(19) United States
(12) Patent Application Publication
(10) Pub. No.: US 2026/0081237 A1
(43) Pub. Date: Mar. 19, 2026

(54) SYSTEMS AND METHODS FOR IN-LINE LEAK DETECTION OF BATTERY CELLS

(71) Applicant: GM GLOBAL TECHNOLOGY OPERATIONS LLC, Detroit, MI (US)

(72) Inventors: Hassan Ghassemi-Armaki, Northville, MI (US); Masoud MohammadPour, Washington Township, MI (US); Randolph Zeitvogel, Beverly Hills, MI (US); Blair E. Carlson, Ann Arbor, MI (US)

(21) Appl. No.: 18/888,394

(22) Filed: Sep. 18, 2024

(51) Int. Cl. H01M 10/42; G01M 3/18

(52) U.S. Cl. CPC H01M 10/4228; G01M 3/186

(57) ABSTRACT

A system configured to test battery cells. The system includes: a movable platform; a plurality of test stations movable by the movable platform, each one of the plurality of test stations configured to cooperate with a pallet on which the battery cells are seated, each one of the plurality of test stations including probes that are movable into cooperation with the battery cells and configured to inject gas into each one of the battery cells; and a camera adjacent to the movable platform and configured to detect leakage of the gas out from within any of the battery cells.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for in-line leak detection of battery cells.

Battery cells are used to power a wide variety of devices and systems. For example, battery cells are power sources for battery electric vehicles (BEVs), plug-in hybrid electric vehicles (PHEVs), and hybrid electric vehicles (HEVs). Various types of battery cells may be used, such as cylindrical battery cells, for example. Each cell includes an outer case, which is sealed to prevent the contents thereof from exiting the cell. Battery cell manufacturing processes include quality control checks to ensure the integrity of each battery cell.

### SUMMARY

The present disclosure includes, in various features, a system configured to test battery cells. The system includes: a movable platform; a plurality of test stations movable by the movable platform, each one of the plurality of test stations configured to cooperate with a pallet on which the battery cells are seated, each one of the plurality of test stations including probes that are movable into cooperation with the battery cells and configured to inject gas into each one of the battery cells; and a camera adjacent to the movable platform and configured to detect leakage of the gas out from within any of the battery cells.

In further features, the movable platform is circular.

In further features, an input conveyor line configured to transport the pallet to the movable platform and an output conveyor line configured to transport the pallet away from the movable platform after the battery cells are scanned by the camera.

In further features, each one of the plurality of test stations includes an entry gate and an exit gate spaced apart to accommodate the pallet therebetween, each one of the entry gate and the exit gate is configured to be opened and closed to permit transport of the pallet to and from the plurality of test stations.

In further features, the probes are movable vertically.

In further features, the gas is carbon dioxide.

In further features, the camera is an infrared camera including a filter configured to block transmission of infrared radiation outside of a wavelength range of 4-5 μm.

In further features, each one of the plurality of test stations further includes a back plate on a side of the pallet opposite to the camera, the back plate configured as a background radiation source for the camera and configured to be heated to a temperature of 10° C.-30° C. greater than an ambient temperature.

In further features, a pump is configured to pump the gas through the probes to the battery cells at a pressure of no greater than 1 psi.

In further features, the gas injected into the battery cells is a first gas injected prior to addition of an electrolyte within the battery cells; and the camera is further configured to detect leakage of a second gas out from within any of the battery cells subsequent to installation of an anode, a cathode, and an electrolyte, the second gas is different from the first gas.

In further features, the camera is an infrared camera including a filter configured to block transmission of infrared radiation outside of a wavelength range of 5-12 μm to detect the second gas.

In further features, the movable platform is configured to move a first station of the plurality of test stations to a first position at which a first pallet with a first group of the battery cells thereon is coupled to the first station between an entry gate and an exit gate of the first station, the battery cells devoid of an electrolyte; the movable platform is configured to move the first station to a second position at which a carrier is configured to move the probes into contact with the battery cells and a pump is configured to pump gas through the probes into the battery cells; the movable platform is configured to move the first station to a third position at which the probes remain in contact with the battery cells and the battery cells remain filled with the gas; the movable platform is configured to move the first station to a fourth position at which the camera is configured to scan the battery cells for leakage of the gas out from within the battery cells, and the carrier is configured move the probes away from contacting the battery cells after the camera has scanned the battery cells for leakage of the gas; the movable platform is configured to move the first station to a fifth position at which the exit gate is configured to open to permit the pallet to be transported away from the movable platform; and the movable platform is configured to move the first station back to the first position to accept an additional pallet with additional battery cells for testing.

In further features, identification tags are included with the pallet and the additional pallet to track movement and results of the camera.

In further features, the plurality of test stations include the first station and seven additional stations identical to the first station to simultaneously test additional ones of the battery cells.

The present disclosure also includes, in various features, a system configured to test battery cells, the system comprising: a rotatable platform; a plurality of test stations spaced apart in a circle about the rotatable platform and configured to rotate with the rotatable platform; probes included with each of the plurality of test stations, the probes are vertically movable into cooperation with the battery cells and configured to inject gas into the battery cells; an infrared camera adjacent to the rotatable platform and configured to detect leakage of the gas out from within any of the battery cells; an input conveyor line in cooperation with the rotatable platform and configured to feed the battery cells to the rotatable platform; and an output conveyor line in cooperation with the rotatable platform to carry the battery cells away from the rotatable platform.

In further features, each one of the plurality of test stations includes a heated backplate configured as a background radiation source for the infrared camera.

In further features, the infrared camera includes a filter configured to block transmission of infrared radiation outside of a wavelength of 4-5 μm.

The present disclosure also includes, in various features, a method for testing battery cells. The method includes: transporting pallets with the battery cells thereon to a rotatable platform including a plurality of test stations, the plurality of test stations including probes movable into cooperation with the battery cells and configured to inject gas into the battery cells; coupling the pallets the plurality of test stations; moving the probes into cooperation with openings defined by the battery cells; injecting gas through the probes and into the battery cells through the openings; rotating the rotatable platform to move the plurality of test stations and the battery cells to an infrared camera configured to detect leakage of the gas out from within any of the battery cells; and with the openings of the battery cells plugged by the probes, activating the infrared camera to detect leakage of the gas out from within any of the battery cells at areas apart from the openings and assessing structural integrity of the battery cells based on detection of the gas having leaked out from within of the battery cells.

In further features, the method includes moving the pallets with the battery cells thereon to the rotatable platform across an input conveyor line in cooperation with the rotatable platform, and moving the pallets with the battery cells thereon away from the rotatable platform across an output conveyor line in cooperation with the rotatable platform.

In further features, the gas is a first gas, the method further including, subsequent to sealing the openings of the battery cells, activating the infrared camera to detect leakage of a second gas out from within the battery cells, the second gas is different from the first gas.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of an exemplary system in accordance with the present disclosure configured to test battery cells;

FIG. 2 is a perspective view of an exemplary test station of the system of FIG. 1;

FIG. 3 is a perspective view of an exemplary battery cell that the system of FIG. 1 is configured to test;

FIG. 4 illustrates features of an exemplary method in accordance with the present disclosure for testing battery cells;

FIG. 5 illustrates additional features of an exemplary method in accordance with the present disclosure for testing battery cells;

FIG. 6 illustrates further features of an exemplary method in accordance with the present disclosure for testing battery cells;

FIG. 7 illustrates still additional features of an exemplary method in accordance with the present disclosure for testing battery cells; and

FIG. 8 illustrates additional features of an exemplary method in accordance with the present disclosure for testing battery cells.

In the drawings, reference numbers may be reused to identify similar and/or identical elements.

### DETAILED DESCRIPTION

The present disclosure is directed to systems and methods for in-line leak detection of battery cells. The systems and methods may be used to test any suitable battery cells configured to power any suitable device. The battery cells may cylindrical battery cells, for example. The battery cells may be configured to power any suitable device, such as a vehicle. With respect to vehicles, the battery cells may be configured to power battery electric vehicles (BEVs), plug-in hybrid electric vehicles (PHEVs), or hybrid electric vehicles (HEVs), for example. The battery cells may be configured for any other suitable non-automotive use as well. The systems and methods of the present disclosure are thus applicable to automotive and non-automotive applications as well.

The battery cells may be manufactured using any suitable manufacturing process. Exemplary manufacturing processes include sealing one or more components of an external casing together, such as by welding or otherwise securing a cover to case. The cover may be sealed prior to addition of an electrolyte, for example. The present disclosure provides for systems and methods for testing the integrity of the battery cells, such as the integrity of the seal of the cover. The testing may be performed prior to the introduction of the electrolyte by injecting a trace gas (such as carbon dioxide) into the battery cells, and then scanning the battery cells for leakage of the gas with any suitable sensor. Suitable sensors include an infrared camera configured to detect carbon dioxide. The systems and methods of the present disclosure are configured to scan for leaks in a very large number of battery cells in-line during manufacturing of the battery cells. For example, the systems and methods of the present disclosure are configured to scan at least 1,800 battery cells per hour. Subsequent to the introduction of the electrolyte, the present disclosure is also configured to perform in-line scans of the battery cells for any potential electrolyte leakage.

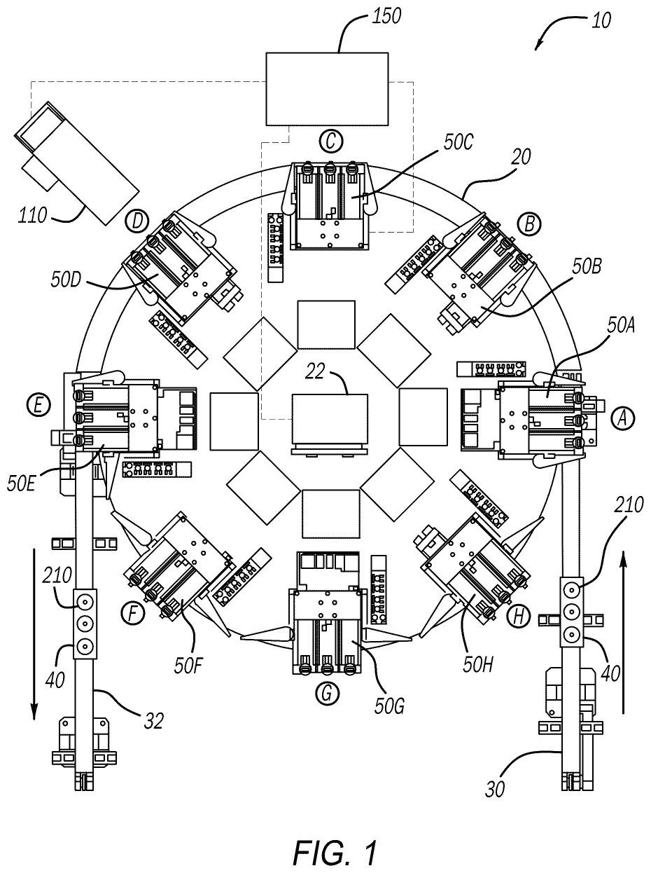

FIG. 1 illustrates an exemplary battery cell test system 10 in accordance with the present disclosure. The system 10 generally includes a movable platform 20, which may take the form of a rotatable base as illustrated or any other transport device or system configured to transport battery cells within the system 10. A motor 22 is included and configured to move the movable platform 20. The motor 22 may be configured to rotate the movable platform 20 in the example illustrated. The system 10 includes an input conveyor line 30 configured to transport batteries to the movable platform 20, and an output conveyor line 32 configured to transport batteries from the movable platform 20. As described herein, the movable platform 20 permits in-line battery inspection and testing, which enhances the process of assembling and inspecting batteries. The system 10 is configured to process 1,800 battery cells per hour, for example.

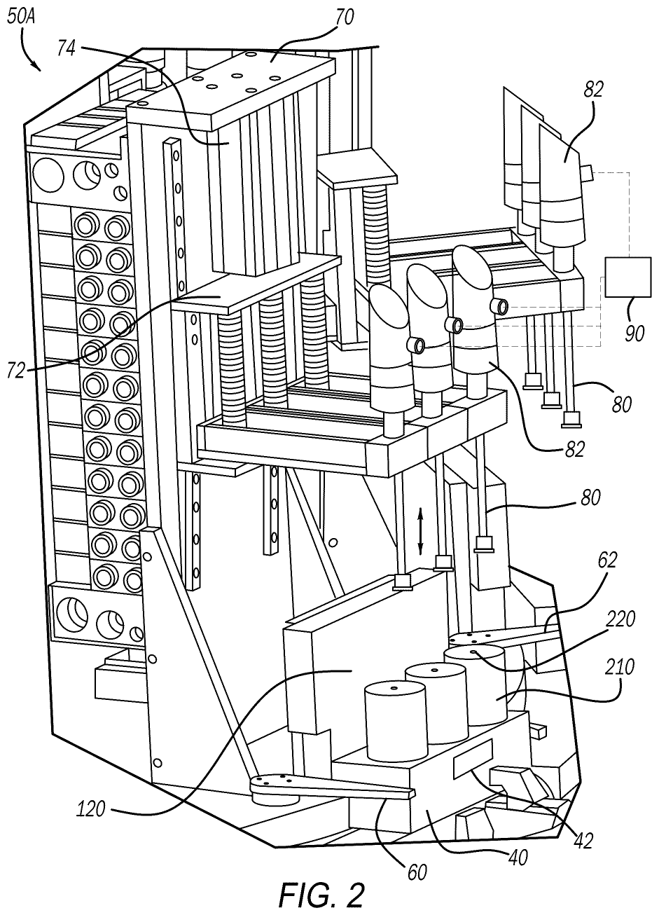

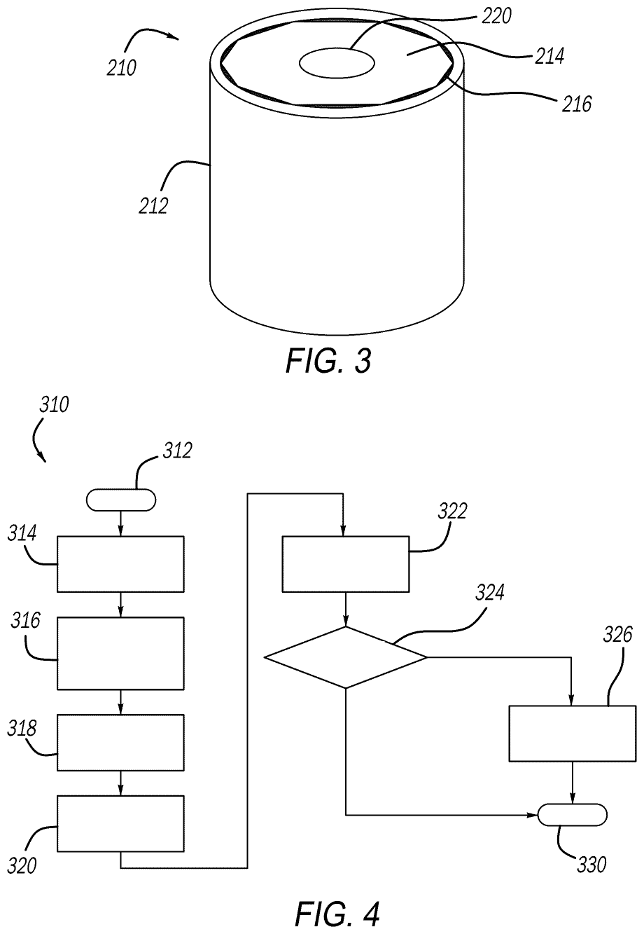

Batteries are transported through the system 10 on pallets 40, or any other suitable movable platforms. The pallets 40 may be sized and shaped to carry any suitable number of batteries, such as three cylindrical battery cells 210 as illustrated in the examples of FIGS. 1 and 2. FIG. 3 illustrates an exemplary battery cell 210, which will be described further herein.

The system 10 includes a plurality of test stations for testing the battery cells 210. The test stations are mounted to the movable platform 20, and moved with the rotatable platform 20. In the example illustrated in FIG. 1, the test stations rotate with the movable platform 20. The movable platform 20 may include eight test stations: a first test station 50A; a second test station 50B; a third test station 50C; a fourth test station 50D; a fifth test station 50E; a sixth test station 50F; a seventh test station 50G; and an eighth test station 50H. The test stations 50A-50H are evenly spaced apart about the rotatable platform 20, which in the example illustrated is a circular turntable.

Rotation of the movable platform 20 by the motor 22 moves the test stations 50A-50H to different test positions. In the example of FIG. 1: the first test station 50A is at a first test position A; the second test station 50B is at a second test position B; the third test station 50C is at a third test position C; the fourth test station 50D is at a fourth test position D; the fifth test station 50E is at a fifth test position E; the sixth test station 50F is at a sixth test position F; the seventh test station 50G is at a seventh test position G; and the eighth test station 50H is at an eight test position H. The movable platform 20 is rotatable by the motor 22 counter-clockwise in 45° increments. Thus, the movable platform 20 is rotatable to move the first test station 50A from the first position A to the second position B, move the second test station 50B from the second position B to the third position C, etc. The other test stations 50B-50H are likewise movable with the platform to the different test positions A-H.

The test stations 50A-50H are identical to each other, or substantially identical. FIG. 2 illustrates the first test station 50A, which will now be described in further detail. The description of the first test station 50A also applies to the test stations 50B-50H. The first test station 50A includes an entry gate 60 and an exit gate 62, each of which are movable to control entry and exit of one of the pallets 40 into cooperation with the first test station 50A. For example, with the entry gate 60 open and the exit gate 62 closed, the pallet 40 carrying three of the battery cells 210 may be transported to the first test station 50A. The entry gate 60 is then closed to secure the pallet between the entry gate 60 and the exit gate 62. As a result, the pallet 40 will rotate with the first test station 50A as the movable platform 20 rotates the first test station 50A to the different positions A-H. Each one of the other test stations 50A-50H is configured to cooperate with a different pallet 40 to move the pallets 40 with battery cells 210 thereon to the different positions A-H. Each one of the pallets 40 includes an identification tag 42, such as an RF ID tag or any other suitable tracking tag or other tracking feature.

The first test station 50A further includes a tower 70 to which is mounted a carrier 72. The carrier 72 is movable vertically along the tower 70 by a pneumatic cylinder 74, or any other suitable actuation device. Attached to the carrier 72 are a plurality of probes 80. Each probe 80 extends from a housing 82, which is in fluid communication with a pump 90 and a gas source. The pump 90 is configured to pump any suitable gas to the housings 82 at any suitable pressure (such as 1 psi, for example) and through the probes 80 to the battery cells 210 as described herein. Any suitable gas may be used, such as carbon dioxide. The probes 80 are vertically movable by the carrier 72 to and away from the battery cells 210. The pneumatic cylinder 74 is configured to move vertically 100 mm, or about 100 mm.

The system 10 further includes a camera 110, which is any suitable sensor configured to detect trace gas (such as carbon dioxide, CO₂) emanating from within the battery cell 210. The camera 110 is positioned about the movable platform. In the example of FIG. 1, the camera 110 is positioned at station D. The camera 110 may be configured as an infrared camera including a filter configured to block transmission of infrared radiation outside of a wavelength of 4-5 μm in order to detect any trace gas, such as CO₂, emanating from within the battery cell 210. Each test station 50A-50H further includes a back plate 120 behind the pallet 40 with the battery cells 210. At test station D, the back plate 120 will be on a side of the battery cells 210 opposite to the camera 110. Thus, the battery cells 210 will be between the camera 110 and the back plate 120. The back plate 120 is configured to be heated above ambient temperature to a temperature of 10° C.-30° C. greater than ambient. The camera 110 is configured to capture middle wavelength infrared (MWIR) images of the battery cells 210 using the back plate 120 as a background panel, as described further herein.

FIG. 3 illustrates an exemplary battery cell 210. The battery cell 210 is configured as a cylindrical cell. The battery cell test system 10 may be configured to assess the integrity of any other suitable battery cell as well. The battery cell 210 generally includes a case 212 and a cover 214 (or lid) that is sealed to the case 212 with any suitable seal 216. At a center of the cover 214 is a center aperture 220. The center aperture 220 may be configured as a fill port, such as for filling the battery cell 210 with an electrolyte. Prior to filling the cell with the electrolyte, the system 10 is configured to test the integrity of the seal 216 as described herein. After the battery cell 210 is filled with the electrolyte (and an anode and cathode is seated therein), the center aperture 220 is sealed closed. The system 10 is further configured to assess structural integrity of the sealed center aperture 220 as well, as described herein.

The system 10 further includes a control module 150, which is configured to control the system 10, or any other suitable battery cell test system to provide the described functionality. For example, the control module 150 is in communication with the motor 22 to operate the motor 22 to rotate the movable platform 20 as described. The control module 150 is further in communication with the each one of the test stations 50A-50H to move the probes 80 to and from the center apertures 220 as described herein. The control module 150 is configured to operate the pump 90 to pump gas through the probes 80 and through the center apertures 220, and configured to operate the camera 110 to detect any gas that has leaked through the seal 216 or at any other relevant location. The control module 150 is further configured to control operation of the entry gate 60 and the exit gate 62.

In some applications the control module 150 may be further configured to operate the pump 90, or any other suitable vacuum generation device, to generate a vacuum at a seal closing the center aperture 220 to test whether the seal at the center aperture 220 is sufficient to retain electrolyte and other contents of the battery cell 210 within the battery cell 210. In such applications, the control module 150 is configured to operate the camera 110 to identify any electrolyte or other vapors, gases, etc. that have been pulled out from within the battery cell 210 by a vacuum created by the probes 80. The camera 110 will include a filter configured to block transmission of infrared radiation outside of a wavelength range of 5-12 μm.

The control module 150 may be configured to rotate the movable platform 20 such that each test station 50A-50H spends a predetermined amount of time at each position A-H, such as 5 seconds at each position A-H and 1 second in transition between the positions A-H. FIG. 4 illustrates an exemplary method 310 for operation of the system 10. The method 310, as well as the methods 410, 510, 610, and 710 set forth herein will now be primarily described with reference to the first test station 50A, but the methods equally apply to the test stations 50B-50H as well.

At block 312 of the method 310, the control module 150 operates the motor 22 to rotate the first test station 50A to the first position A, and at block 314 the control module 150 operates any suitable motor or actuation mechanism to close the exit gate 62. At this stage in the method 310, the entry gate 60 will be open from the release of a previous pallet 40. At block 316, the control module 150 operates the input conveyor line 30 to move the pallet 40 carrying the battery cells 210 past the open entry gate 60 to the first position A. The closed exit gate 62 prevents the pallet 40 from traveling past the first position A. At this stage, the battery cells 210 will each include the case 212 and the cover 214 sealed to the case 212 at the seal 216. The center aperture 220 will be open and no electrolyte will be in the battery cells 210.

At block 318, the pallet 40 arrives at the first test station 50A positioned at the first position A. At block 320, the control module 150 is configured to close the entry gate 60 in any suitable manner, such as by actuating a motor in cooperation with the entry gate 60. With the pallet 40 between the closed entry gate 60 and the closed exit gate 62, the pallet 40 is coupled with the first test station 50A to rotate with the first test station 50A from the first position A to the fifth station E as described herein. At block 322, the identification tag 42 of the pallet 40 is read by any suitable scanning device. The identification tag 42 provides various information regarding the battery cells 210 on the pallet 40. For example, the identification tag 42 may identify the type of battery cell, the type of seal 216, date of the seal 216, part and lot number, end use, manufacture date, etc. If at block 324 various predetermined prerequisites are met, the control module 150 advances the method to block 326 where the control module 150 operates the pneumatic cylinder 74 to lower the carrier 72 and the probes 80 to seal against the center apertures 220. After the probes 80 are lowered, the method 310 proceeds to block 330 where the cycle of the first position A is complete. If the predetermined prerequisites are not met at block 324, the method 310 skips block 326 and proceeds from block 324 directly to block 330.

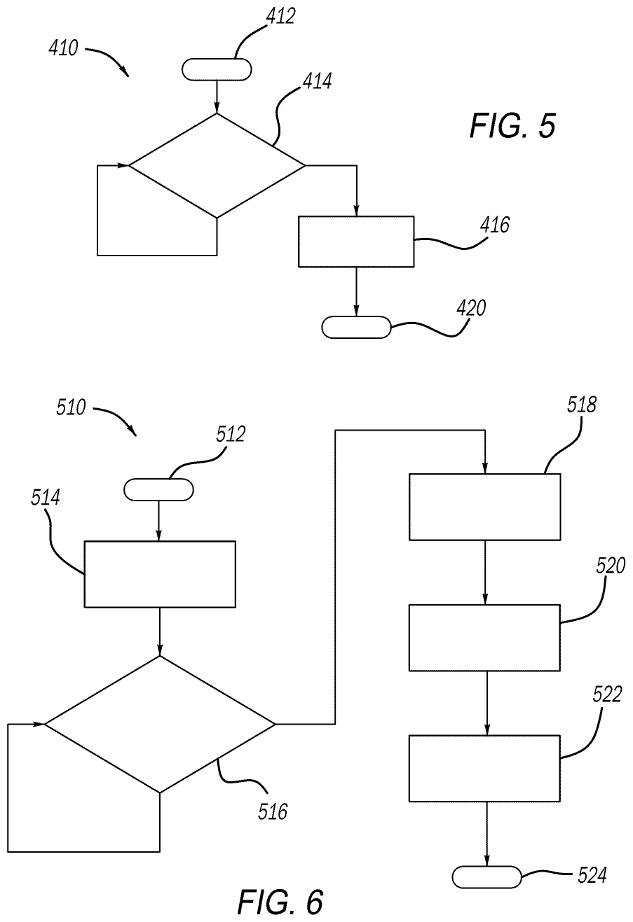

FIG. 5 illustrates another method 410 in accordance with the present disclosure for operating the system 10 at the second position B. At block 412, the control module 150 operates the motor 22 to rotate the movable platform 20 to advance the first test station 50A from the first position A to the second position B. At block 414, the control module 150 checks whether the probes 80 are still extended to the center apertures 220. If the probes 80 are still extended, at block 416 the control module 150 operates the pump 90 to pump any suitable gas (such as CO₂) through the probes 80 and into the battery cells 210 through the open center apertures 220. At block 420, the operation cycle at the second position B is complete. From the second position B, the control module 150 is configured to operate the motor 22 to rotate the first test station 50A to the third position C. At the third position C, no action is taken on the battery cells 210.

FIG. 6 illustrates a method 510 for operation of the system 10 at the fourth position D. At block 512, the control module 150 is configured to operate the motor to rotate the movable platform 20 to move the first test station 50A from the third position C to the fourth position D. As explained above, the camera 110 is mounted at the fourth position D. At block 514, the control module 150 is configured to operate the camera 110 to inspect the battery cell 210 for leakage of the gas pumped into the battery cells 210 through the probes 80, which are still at the center aperture 220 to close the center aperture 220. The control module 150 operates the camera 110 to capture one or more infrared images of each of the battery cells 210.

At block 516, after capturing, and optionally saving, middle wavelength infrared (MWIR) images at any suitable storage device of the control module 150 (or associated with the control module 150) the control module 150 is configured to analyze the captured infrared images to ascertain whether or not a gas leak is present at the seal 216 or at any other relevant location of the battery cell 210 (such as at the case 212 or the cover 214). In a non-limiting example, an image analysis module of the control module 150 examines each infrared image captured by the camera 110 to evaluate MWIR waves passing between the back plate 120, which is heated, and the battery cell 210 (e.g., along an upper edge of the battery cell 210 at the seal 216. The image analysis module of the control module 150 may use any suitable gas cloud modeling algorithm, for example, to locate one or more aberrations, if any, within the imaged MWIR waves. The control module 150 is configured to determine that each aberration is caused by compressed CO₂ gas (or any other suitable gas injected by the probes 80 into the battery cells 210) leaking from the battery cell 210 (e.g., leaking from the seal 216 that has cracked or otherwise had its integrity compromised).

At block 516, the control module 150 determines whether a gas leak has been detected, or a predetermined inspection period has elapsed without detection of a leak. The predetermined inspection period may be 4.5 seconds, for example, or any other suitable inspection period. Once a gas leak has been detected or the predetermined inspection period has elapsed, the control module proceeds from block 516 to block 518. At block 518, the control module 150 ends the inspection by the camera 110, and at block 520 the results of the inspection are recorded and associated with the identification tag 42. From block 520, the method 510 proceeds to block 522 where the control module operates the pneumatic cylinder to raise the probes 80 out from cooperation with the center aperture 220 of the battery cell 210.

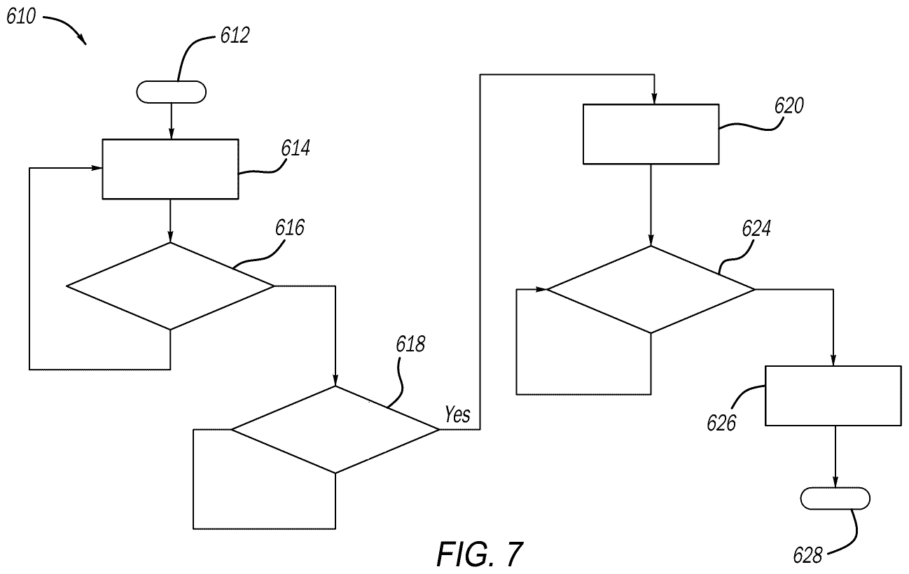

From the method 510, the control module 150 proceeds to the method 610 of FIG. 7, which controls operation of the system 10 at the fifth position E. At block 612, the control module 150 operates the motor 22 to rotate the first test station 50A to the fifth position E. At block 614, the control module 150 reads the identification tag using any suitable scanning device. At block 616, the control module 150 checks the data associated with the identification tag 42 for completeness (e.g., completeness of the results of the camera inspection). If the data is complete, the control module 150 proceeds to block 618, where the control module 150 is configured to operate the pneumatic cylinder 74 to raise the carrier 72, which raises the probes 80 out from cooperation with the battery cells 210.

After the probes 80 are raised, the control module 150 is configured to open the exit gate 62 at block 620. With the exit gate 62 open, the output conveyor line 32 is able to pull the pallet 40 off of the movable platform 20 and out of the system 10 to a subsequent manufacturing/test location. After the pallet 40 has exited the system 10, the control module 150 opens the entry gate 60 in preparation for receiving an additional pallet 40 with additional battery cells 210 for inspection. At block 628, operation at the fifth station E is complete, and the control module 150 is configured to operate the motor 22 to rotate the platform 20 in 45° increments through the sixth station F, the seventh station G, and the eight station H. No operations take place at the sixth station F, the seventh station G, or the eighth station H. From the eighth station H, the first test station 50A is rotated back to the first position A where another pallet 40 is received for inspection of battery cells 210 thereon.

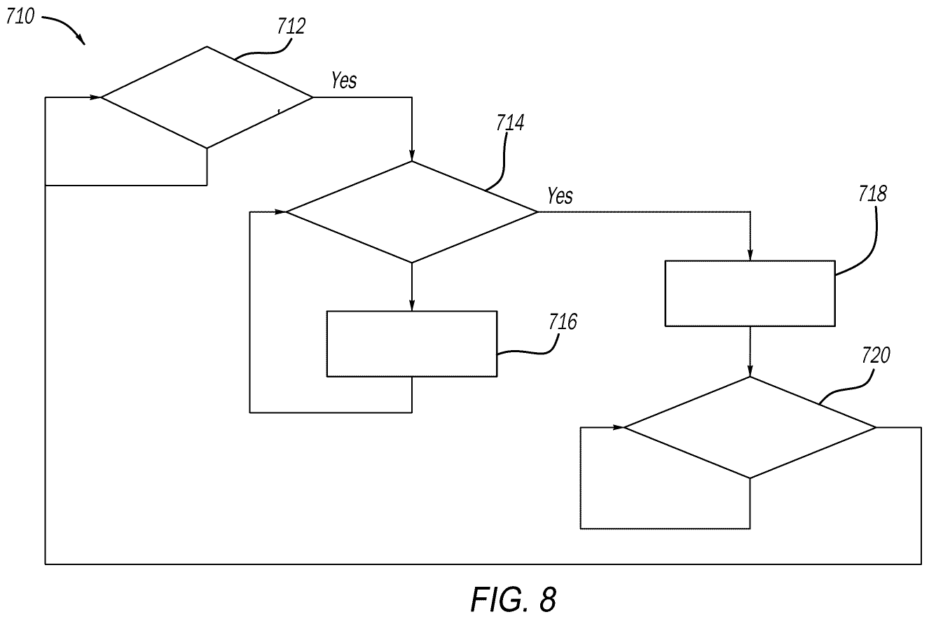

FIG. 8 illustrates an overall method 710 for operation of the system 10 by the control module. At block 712, the control module 150 maintains the movable platform 20, and the test stations 50A-50H, at each position A-H for a predetermined time period for the processing at each station to take place, such as inspection by the camera 110 at the fourth position D. The predetermined time period may be 5 seconds, for example. Once the predetermined time period has expired as measured by the control module 150, the method 710 proceeds to block 714, wherein the control module 150 determines whether processing at all of the test stations 50A-50H has completed. For example, the control module 150 will determine whether the inspection by the camera 110 is complete and whether the injection of gas at the first position A is complete. If all stations are not complete, the method 710 proceeds to block 716 where an over cycle warning is issued by the control module 150. In response to the warning, an operator may inspect the system 10 for a failure. If at block 714 the control module 150 determines that all stations are complete, at block 718 the control module 150 will operate the motor 22 to index the movable platform 45°. Once the index is complete, the method 710 returns to block 712.

The system 10 and corresponding methods 310-610 may also be configured to detect leakage of electrolyte and electrolyte-related vapors out through the seal 216 or the center aperture 220 after the electrolyte has been added to the battery cells 210. The operation of the probes 80 is modified to create a vacuum attempting to draw electrolyte-related vapors out from within the battery cells 210 through the seal 216 or a seal at the center aperture 220. The camera 110 is modified with a filter configured to block transmission of infrared radiation outside of a wavelength range of 5-12 μm to detect the electrolyte-related vapors. At the fourth position D, the control module 150 operates the camera 110 to scan for any electrolyte-related vapors that may be passing through the seal 216 or the sealed center aperture 220. Any of the battery cells 210 experiencing leaks may be identified and processed accordingly.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A system configured to test battery cells, the system comprising:
a movable platform;
a plurality of test stations movable by the movable platform, each one of the plurality of test stations configured to cooperate with a pallet on which the battery cells are seated, each one of the plurality of test stations including probes that are movable into cooperation with the battery cells and configured to inject gas into each one of the battery cells; and
a camera adjacent to the movable platform and configured to detect leakage of the gas out from within any of the battery cells.

2. The system of claim 1, wherein the movable platform is circular.

3. The system of claim 1, further comprising an input conveyor line configured to transport the pallet to the movable platform and an output conveyor line configured to transport the pallet away from the movable platform after the battery cells are scanned by the camera.

4. The system of claim 1, wherein each one of the plurality of test stations includes an entry gate and an exit gate spaced apart to accommodate the pallet therebetween, each one of the entry gate and the exit gate is configured to be opened and closed to permit transport of the pallet to and from the plurality of test stations.

5. The system of claim 1, wherein the probes are movable vertically.

6. The system of claim 1, wherein the gas is carbon dioxide.

7. The system of claim 1, wherein the camera is an infrared camera including a filter configured to block transmission of infrared radiation outside of a wavelength range of 4-5 μm.

8. The system of claim 1, wherein each one of the plurality of test stations further includes a back plate on a side of the pallet opposite to the camera, the back plate configured as a background radiation source for the camera and configured to be heated to a temperature of 10° C.-30° C. greater than an ambient temperature.

9. The system of claim 1, further comprising a pump configured to pump the gas through the probes to the battery cells at a pressure of no greater than 1 psi.

10. The system of claim 1, wherein:
the gas injected into the battery cells is a first gas injected prior to addition of an electrolyte within the battery cells; and
the camera is further configured to detect leakage of a second gas out from within any of the battery cells subsequent to installation of an anode, a cathode, and an electrolyte, the second gas is different from the first gas.

11. The system of claim 10, wherein the camera is an infrared camera including a filter configured to block transmission of infrared radiation outside of a wavelength range of 5-12 μm to detect the second gas.

12. The system of claim 1, wherein:
the movable platform is configured to move a first station of the plurality of test stations to a first position at which a first pallet with a first group of the battery cells thereon is coupled to the first station between an entry gate and an exit gate of the first station, the battery cells devoid of an electrolyte;
the movable platform is configured to move the first station to a second position at which a carrier is configured to move the probes into contact with the battery cells and a pump is configured to pump gas through the probes into the battery cells;
the movable platform is configured to move the first station to a third position at which the probes remain in contact with the battery cells and the battery cells remain filled with the gas;
the movable platform is configured to move the first station to a fourth position at which the camera is configured to scan the battery cells for leakage of the gas out from within the battery cells, and the carrier is configured move the probes away from contacting the battery cells after the camera has scanned the battery cells for leakage of the gas;
the movable platform is configured to move the first station to a fifth position at which the exit gate is configured to open to permit the pallet to be transported away from the movable platform; and
the movable platform is configured to move the first station back to the first position to accept an additional pallet with additional battery cells for testing.

13. The system of claim 12, further comprising identification tags included with the pallet and the additional pallet to track movement and results of the camera.

14. The system of claim 12, wherein the plurality of test stations include the first station and seven additional stations identical to the first station to simultaneously test additional ones of the battery cells.

15. A system configured to test battery cells, the system comprising:
a rotatable platform;
a plurality of test stations spaced apart in a circle about the rotatable platform and configured to rotate with the rotatable platform;
probes included with each of the plurality of test stations, the probes are vertically movable into cooperation with the battery cells and configured to inject gas into the battery cells;
an infrared camera adjacent to the rotatable platform and configured to detect leakage of the gas out from within any of the battery cells;
an input conveyor line in cooperation with the rotatable platform and configured to feed the battery cells to the rotatable platform; and
an output conveyor line in cooperation with the rotatable platform to carry the battery cells away from the rotatable platform.

16. The system of claim 15, wherein each one of the plurality of test stations includes a heated backplate configured as a background radiation source for the infrared camera.

17. The system of claim 15, wherein the infrared camera includes a filter configured to block transmission of infrared radiation outside of a wavelength of 4-5 μm.

18. A method for testing battery cells comprising:
transporting pallets with the battery cells thereon to a rotatable platform including a plurality of test stations, the plurality of test stations including probes movable into cooperation with the battery cells and configured to inject gas into the battery cells;
coupling the pallets the plurality of test stations;
moving the probes into cooperation with openings defined by the battery cells;
injecting gas through the probes and into the battery cells through the openings;
rotating the rotatable platform to move the plurality of test stations and the battery cells to an infrared camera configured to detect leakage of the gas out from within any of the battery cells; and
with the openings of the battery cells plugged by the probes, activating the infrared camera to detect leakage of the gas out from within any of the battery cells at areas apart from the openings and assessing structural integrity of the battery cells based on detection of the gas having leaked out from within of the battery cells.

19. The method of claim 18, moving the pallets with the battery cells thereon to the rotatable platform across an input conveyor line in cooperation with the rotatable platform, and moving the pallets with the battery cells thereon away from the rotatable platform across an output conveyor line in cooperation with the rotatable platform.

20. The method of claim 18, wherein the gas is a first gas, the method further comprising, subsequent to sealing the openings of the battery cells, activating the infrared camera to detect leakage of a second gas out from within the battery cells, the second gas is different from the first gas.
